(19) United States
(12) Patent Application Publication
(10) Pub. No.: US 2019/0295199 A1
(43) Pub. Date: Sep. 26, 2019

(54) INTELLIGENT LEGAL SIMULATOR

(71) Applicant: Trial Boom LLC, Castle Rock, CO (US)

(72) Inventors: Roderick Jess O'Dorisio, Denver, CO (US); David Conrad Schott, Castle Rock, CO (US); Justin Paul Mette, Centennial, CO (US); Bradley Hale Moloney, Broomfield, CO (US); Diana Sada, Denver, CO (US)

(21) Appl. No.: 16/206,132

(22) Filed: Nov. 30, 2018

Related U.S. Application Data
(60) Provisional application No. 62/593,851, filed on Dec. 1, 2017.

(51) Int. Cl. G06Q 50/18; G06F 17/50

(52) U.S. Cl. CPC G06Q 50/18; G06F 17/5009

(57) ABSTRACT

An intelligent legal simulator providing at least one intelligent legal environment including, but not limited to, an intelligent courtroom. The intelligent legal simulator may comprise at least one asset, which may be powered by a machine-learning algorithm utilizing artificial intelligence. An artificially-intelligent asset may be created and/or updated according to input received by the intelligent legal simulator system. The intelligent legal simulator may become more independently intelligent as it receives more information. A user may engage with the intelligent legal simulator via a mobile device, tablet, personal computer, head-mounted display, or other similar computing device. The intelligent legal simulator and its artificially-intelligent assets may simulate real legal scenarios, including jury trials, hearings, depositions, voir dire, mediations, arbitrations, administrative hearings, tribunals, international proceedings, and other legal-related procedures.

### CROSS REFERENCE TO RELATED APPLICATIONS

The present Application for Patent claims priority to U.S. Provisional Patent Application No. 62/593,851, filed Dec. 1, 2017, and assigned to the assignee hereof and hereby expressly incorporated by reference herein.

### BACKGROUND

Many practicing and aspiring attorneys are currently limited from obtaining real-world litigation experience due to insufficient resources. The options that are currently available primarily consist of shadowing more senior or more experienced attorneys in the courtroom, engaging in trial practicum courses offered at academic institutions, participating in mock trial organizations and competitions, or watching recorded or live-feed trials and legal proceedings on an electronic device. As such, the current offering of resources for aspiring and practicing attorneys to obtain real-world legal experience and improve advocacy skills is limited by physical reality.

In today's hyper-competitive legal landscape, it can be difficult for lawyers to acquire practical litigation experience—taking and defending depositions, arguing motions and hearings, and examining witnesses at trial—especially for associates at midsize and large firms. It is common to hear anecdotes about a mid-level associate who has done nothing but document review or the senior associate who has never taken a deposition, let alone examined a witness at trial. One opinion published by the American Bar Association suggests two avenues for associates to gain practical courtroom experience: (a) get involved early with pro bono litigation and (b) assist with non-billable legal work for litigation partners in hopes of landing a litigation assignment in the future. Not only are those opportunities often impractical, they are also not guaranteed to provide the associate with adequate courtroom experience. Pro bono litigation matters may settle early before trial, and simply working on non-billable legal work for a senior partner does not always lead to future litigation assignments. As such, the opportunities for aspiring attorneys and associates to gain real-world litigation experience are severely lacking and limited.

With fewer cases heading to trial and with those that do often considered the types of high-stakes battles that clients insist be handled by partners, young attorneys are left scrambling for opportunities to gain crucial experience before a judge and jury. The percentage of federal court cases that are resolved through trial has plummeted over the last several decades to less than 2%. The American civil jury trial is indeed an endangered species. Yet, a firm's ability to provide trial-capable lawyers is a high-value proposition for clients faced with a possible jury or bench trial. Therefore, a need exists to provide better access to real-world litigation resources.

It is with respect to these and other general considerations that example aspects, systems, and methods have been described. In addition, although relatively specific problems have been discussed, it should be understood that the examples should not be limited to solving specific problems identified in the Background.

### SUMMARY

Aspects of the disclosure provide users with an intelligent legal simulator. The intelligent legal simulator may be equipped with the ability to receive and process natural language from at least one user and/or a database, process the natural language input, determine at least one appropriate action response, and provide at least one action response back to the user.

The intelligent legal simulator may comprise at least one intelligent courtroom environment. In other example aspects, the intelligent legal simulator may comprise other intelligent environments, such as a conference room, an office, or other space. For example, the intelligent legal simulator may provide access to a courtroom simulation through an intelligent virtual courtroom. In another example aspect, the intelligent legal simulator may provide access to a deposition simulation through an intelligent conference room. Regardless of the virtual environment, the intelligent legal simulator may populate each environment with at least one other intelligent asset to simulate at least one lifelike legal experience and/or practice. Such lifelike legal experiences and/or practices may include but are not limited to: a direct examination of a witness, a cross examinations of a witness, depositions, voir dire, discovery, bench trial, appellate arguments and practice, hearings before a judge, and other law-related activities.

The intelligent legal simulator may comprise an intelligent virtual courtroom. The intelligent virtual courtroom may be equipped with at least one artificially intelligent (“AI”) asset, including but not limited to, at least one of an AI judge, AI opposing counsel, AI co-counsel, AI witness, and AI juror. The term “artificial intelligence” may refer to the simulation of human intelligence by machines. An AI judge asset may be constructed through the receiving and processing of historical court data, including but not limited to, trial transcripts, legal opinions, articles, and other related sources. An AI opposing counsel may be constructed through the receiving and processing of a user's natural language input and/or action within the virtual courtroom. According to the processed results of a user's input, among other considerations, the AI opposing counsel may determine at least one appropriate action response to provide to the user. As more input is received and processed by the AI opposing counsel, the more intelligent the AI opposing counsel may become, in some instances.

In further example aspects, the intelligent legal simulator may be equipped with an artificially intelligent educational assistant. The educational assistant may be powered by at least one machine-learning algorithm. The machine-learning algorithm may be user-specific, such that each user may be associated with a least one base algorithm from the educational assistant. Continuous user input within the intelligent legal simulator may cause the at least one base machine-learning algorithm to adapt specifically to that user. For example, a user who specifically struggles with identifying questions articulated by opposing counsel that trigger improper character evidence issues may cause the AI educational assistant to provide more assistance (e.g., third-party resources, links, hints, explanations, etc.) to the user regarding improper character evidence. In yet further example aspects, the AI educational assistant may consider the context in which the user is engaging with the intelligent legal simulator. For example, if a user is training within an intelligent virtual courtroom, the AI educational assistant may determine which Rules of Evidence to apply (e.g., state-specific, federal, international, country-specific, etc.). Additionally, the AI educational assistant may become manifest through at least one of the AI assets within the intelligent virtual courtroom. For example, if a user is struggling with articulating a certain type of evidentiary objection, the AI educational assistant may provide a helpful hint through the AI co-counsel asset. In another example aspect, the AI educational assistant may provide assistance through the AI judge asset. In further example aspects, the AI educational assistant may provide assistance without the use of another AI asset. Instead, the AI educational assistant may provide assistance through other means, including but not limited to, pop-up text, audio clips, video demonstrations, and in-court simulations, which may be automatically constructed or pre-programmed. The AI educational assistant is not limited to a certain intelligent environment or AI asset within the intelligent legal simulator.

In other examples, the intelligent legal simulator may be manually programmed, such that an asset within the intelligent virtual courtroom may respond according to at least one hard-coded logical parameter. For example, an improper witness answer may be hard-coded into the intelligent virtual courtroom. If a user objects correctly to the improper answer, the logical step may trigger a hard-coded action response from the judge (e.g., the judge may “Sustain” the objection). In further example aspects, the intelligent legal simulator may use a combination of at least one machine-learning algorithm and at least one hard-coded logical parameter. For instance, the at least one machine-learning algorithm may use the at least one hard-coded logical parameter as a base case. The machine-learning algorithm may then begin to evolve according to the interaction between input within the intelligent legal simulator and the hard-coded logical parameter that may serve as a base case.

In one aspect, a processor-implemented method of providing an intelligent legal simulator is disclosed herein. Input may be received on a device. The input may then be processed to identify one or more entities associated with the input, wherein at least one entity is associated with the law. At least one action response may be determined, based at least in part upon analyzing the input according to one or more rules. The at least one action response is also associated with the law. The input and the at least one action response may be stored locally and/or remotely. Lastly, the at least one action response is automatically provided.

In another aspect, a computing device is provided, the computing device comprising at least one processing unit and at least one memory storing processor-executable instructions that when executed by the at least one processing unit cause the computing device to create an intelligent legal simulator. Input may be received on a device. The input may then be processed to identify one or more entities associated with the input, wherein at least one entity is associated with the law. At least one action response may be determined, based at least in part upon analyzing the input according to one or more rules. The at least one action response is also associated with the law. The input and the at least one action response may be stored locally and/or remotely. Lastly, the at least one action response is automatically provided.

In yet another aspect, a processor-readable storage medium is provided, the processor-readable storage medium storing instructions for execution by one or more processors of a computing device, the instructions for performing a method for analyzing and processing input related to an intelligent legal simulator. Input may be received on a device. The input may then be processed to identify one or more entities associated with the input, wherein at least one entity is associated with the law. At least one action response may be determined, based at least in part upon analyzing the input according to one or more rules. The at least one action response is also associated with the law. The input and the at least one action response may be stored locally and/or remotely. Lastly, the at least one action response is automatically provided.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTIONS OF THE DRAWINGS

FIG. 1 illustrates an example of a distributed system for implementing an intelligent legal simulator.

FIG. 2 is a block diagram illustrating a method for an intelligent legal simulator.

FIG. 3 is a block diagram illustrating an input processor.

FIG. 4 is a block diagram illustrating a method for creating an artificially intelligent asset within an intelligent legal simulator.

FIG. 5A illustrates an example of an electronic device running an intelligent legal simulator.

FIG. 5B illustrates an example of an electronic device running an intelligent legal simulator.

FIG. 6 illustrates one example of a suitable operating environment in which one or more of the present embodiments of the intelligent legal simulator may be implemented.

### DETAILED DESCRIPTIONS

In the following detailed description, references are made to the accompanying drawings that form a part hereof, and in which are shown by way of illustrations or specific examples. These aspects may be combined, other aspects may be utilized, and structural changes may be made without departing from the present disclosure. Example aspects may be practiced as methods, systems, or devices. Accordingly, example aspects may take the form of a hardware implementation, a software implementation, or an implementation combining software and hardware aspects. The following detailed description is therefore not to be taken in a limiting sense, and the scope of the present disclosure is defined by the appended claims and their equivalents.

The intelligent legal simulator of the present disclosure allows users to acquire real-world legal experience without the need of a physical courtroom and its many assets (e.g., judge, jury, witnesses, opposing counsel, etc.), as well as a physical conference room or other physical space for non-courtroom tasks, such as depositions, mediations, arbitrations, etc. The term “intelligent” may refer to an intelligent system, which may comprise a machine with an embedded computer that has the capacity to gather and analyze data and communicate with other systems. Other characteristics of an intelligent system may include, but are not limited to, the capacity to learn from experience, security, connectivity, the ability to adapt according to current data, and the capacity for remote monitoring and management. A user may access the intelligent legal simulator through a number of electronic devices, including, but not limited to, a personal computer, a mobile phone, a tablet, and a head-mounted display (e.g., Oculus Rift®, Gear VR®, etc.).

As detailed above, the disclosure generally relates to a system and methods for creating an intelligent legal simulator from user input and other data input according to machine learning and natural language processing algorithms. The input may be in a number of textual and non-textual forms, including but not limited to, text input, speech input, and video input. The input may be entered within the intelligent legal simulator application on any suitable electronic device, e.g., mobile phone, tablet, personal computer, head-mounted display (hereinafter “HMD”), etc. The user input may be received by the electronic device as spoken input, keyboard input, touch/stylus input, gesture input, etc. Other non-user input may be received by the electronic device via a distributed system that automatically creates queries, receives requested data, and processes that data across multiple servers and devices. Upon receipt of the user or non-user input, the input may be analyzed by natural language processing using topic segmentation, feature extractions, domain classification, and/or semantic determination. In this way, the input may be parsed to identify entities, such as one or more people, relevant date(s), jurisdiction(s), action(s), location(s), instruction(s), verdict(s), holding(s), etc., for creating an intelligent environment within the intelligent legal simulator. The identified entities may then be used to respond to a user's action(s) within the intelligent legal simulator. For example, data about a certain human judge may be utilized to create an AI judge within an intelligent courtroom environment. Considering local evidentiary rules and the certain judge's previous rulings, the AI judge may respond to an objection from the user in accordance with the received data regarding that specific judge. Other AI assets may also be created and deployed within the intelligent legal simulator and are described in further detail below.

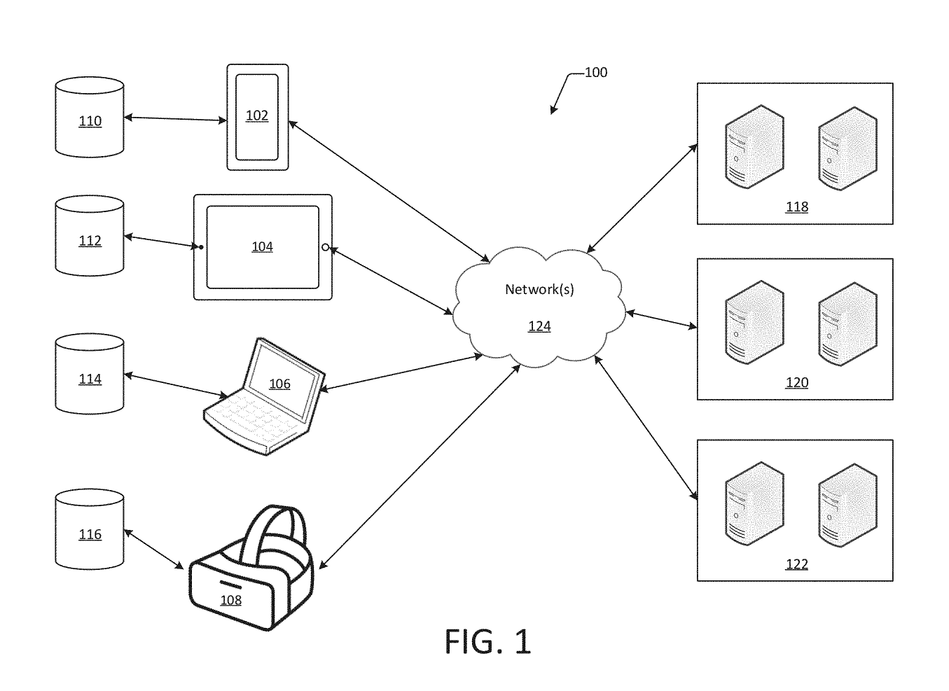

FIG. 1 illustrates an example of a distributed system for implementing an intelligent legal simulator.

A system that facilitates the creation, processing, updating, and displaying of an intelligent legal simulator may be run on an electronic device including, but not limited to, client devices such as a mobile phone 102, a tablet 104, a personal computer 106, and a head-mounted display 108. The disclosed system may receive user input data and/or historical data from a number of applications, including but not limited to, third-party legal databases and applications (e.g., WestLaw®, Lexis Nexis®, etc.), government databases and applications, empirical data collection applications (e.g., Amazon® Mechanical Turk), media databases and applications, etc. User-specific data may also be received from an application running locally on an electronic device. Such user-specific data may be stored on one or more remote servers to be utilized within the intelligent legal simulator. The disclosed system may then process the received data locally, remotely, or using a combination of both. During processing, the disclosed system may rely on local and remote databases to generate the most appropriate action response(s) to provide back to the user(s). This may be accomplished by utilizing local data stored in a local database (such as local databases 110, 112, 114, and 116), a remote database stored on servers 118, 120, and 122, or a combination of both. Additionally, creating and implementing the intelligent legal simulator that provides accurate and current law, as well as current best practices, may utilize an external search engine and third-party websites and/or resources. The external search engine and third-party websites and/or resources may be accessed via network(s) 124, and the retrieved data may be processed on servers 118, 120, and 122.

Mobile phone 102 may utilize local database 110 and access servers 118, 120, and/or 122 via network(s) 124 to process the received data and provide an appropriate action response. In other example aspects, tablet 104 may utilize local database 112 and network(s) 124 to synchronize the relevant tokens extracted from the processed data and the subsequent intelligent assets and action responses across client devices and across all servers running the intelligent legal simulator. For example, if the initial data is received on tablet 104, the data and subsequent action response(s) generation may be saved locally in database 112, but also shared with servers 118, 120, and/or 122 via the network(s) 124.

In other example aspects, the intelligent legal simulator may be deployed locally. For instance, if the system servers 118, 120, and/or 122 are down, the intelligent legal simulator may still operate on a client device, such as mobile device 102, tablet 104, computer 106, and HMD 108. In this case, a subset of the trained dataset applicable to the client device type and at least a client version of the machine-learning and natural language processing algorithms may be locally cached so as to automatically respond to relevant input tokens (i.e., words, phrases, documents, etc.) that may be received by a user or through a database query. The system servers 118, 120, and 122 may be down for a variety of reasons, including but not limited to, power outages, network failures, operating system failures, program failures, misconfigurations, and hardware deterioration.

As should be appreciated, the various methods, devices, components, etc., described with respect to FIG. 1 are not intended to limit systems 100 to being performed by the particular components described. Accordingly, additional topology configurations may be used to practice the methods and systems herein and/or components described may be excluded without departing from the methods and systems disclosed herein.

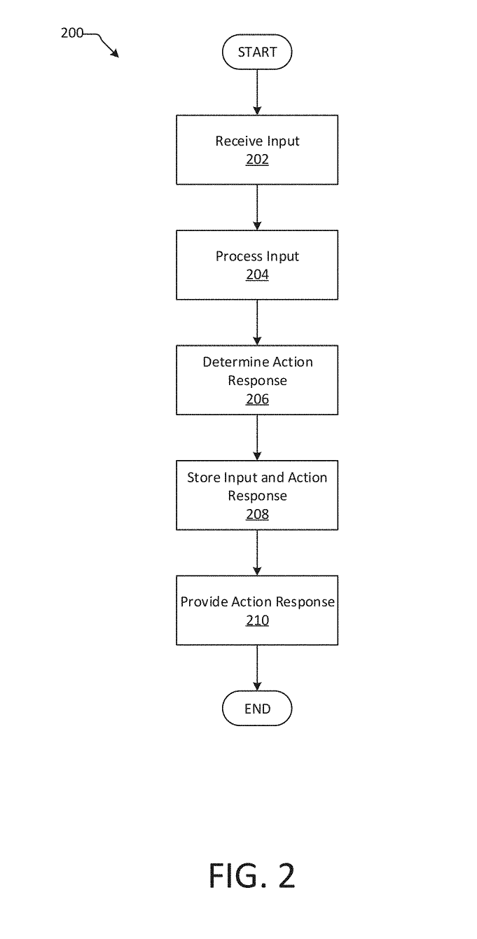

FIG. 2 is a block diagram illustrating a method for an intelligent legal simulator.

Method 200 begins with receive input operation 202. In some example aspects, the input may include, but is not limited to, user input and/or non-user input. User input may consist of contemporaneous input from at least one user. Non-user input may consist of fetching data from a database. Fetching data may be performed through a number of different programming languages and platforms, including but not limited to, MySQL, PHP, Java, JavaScript, AngularJS, C#, and other programming languages and tools. In other example aspects, the receiving of non-user input may comprise of reading-in text documents, such as court transcripts, opinions, orders, and other legal-related documents. In further example aspects, the non-user input may comprise of non-textual inputs, such as audio and/or video recordings.

Receive input operation 202 may receive input automatically. The input may be received from a user via an electronic device. The input may also be received from a database, server, or third-party application. Such data may be received locally or remotely over a network (e.g., network(s) 124). The input data may include, but is not limited to, the identity of the sender of data (e.g., a user identity, a machine identity, etc.), the GPS locations of the sender and user, grammatical features, semantic features, and syntactical features. Additionally, receive input operation 202 may also acquire device data, including operating environment characteristics, battery life, hardware specifications, local files, third-party applications, and other relevant information that may be used to provide a more enjoyable and robust user experience within the intelligent legal simulator. Such comprehensive data acquisition may allow the intelligent legal simulator system to provide more accurate and personalized action responses.

Additionally, receive input operation 202 may receive input in a number of formats, including, but not limited to, textual input, voice input, stylus input, gesture input, and other input mechanisms.

At process input operation 204, the data that was received from operation 202 may be automatically processed. The processing of operation 204 may consist of applying at least one natural language processing (“NLP”) algorithm and/or machine-learning algorithm to the data. The application of at least one NLP or machine-learning algorithm may allow the received data to be sorted, matched, and/or analyzed quickly so that an intelligent action response may be automatically generated according to the results of the processing in operation 204. The natural language processor may identify the most relevant portions of the input data. For example, a sentence ending in a question mark or an exclamation mark may be identified as a more pertinent part of the input data and processed accordingly. In other example aspects, the input phrase “Your Honor” may cause the sentence in which that phrase is contained to receive a high priority ranking than other sentences, since the phrase “Your Honor” usually indicates that the user is addressing the judge. In another example aspect, an input phrase that includes a proper name (e.g., the name of opposing counsel, the name of a witness, etc.) may receive a higher priority and processed earlier than other phrases that do not contain a proper name.

If necessary, the input may be converted to text. For example, if input is received as speech input, a speech-to-text system (e.g., via Cortana® or Siri®) may convert the speech to text. Alternatively, if the input is received as handwritten input (e.g., via touch or stylus), a handwriting-to-text system may convert the stylus or touch input from handwriting to text. After converting the input to text, if necessary, the input may then be further processed by utilizing a natural language processor. In some example aspects, process operation 204 may include comparing historical data regarding the user. For example, the natural language processor of operation 204 may compare current input with historical input for semantic and syntactic patterns to more accurately determine the meaning and intent of the input. In other aspects, process operation 204 may meticulously isolate key words and phrases to identify entities associated with the input. An entity may include any discrete item associated with the input, including third-party applications, specific people or places, events, times, procedural actions, instructions, and other data that may be stored locally on an electronic device or remotely on a server (e.g., cloud server). Processing and analyzing the input may occur in any intelligent environment within the intelligent legal simulator.

For example, during a direct examination of a witness, a user may input, via speech or text, the following question to a witness: “Then, what did she say?” Immediate processing of the question may indicate that this question calls for hearsay, since it is prompting the witness to articulate an out-of-court statement offered for the truth of the matter asserted. However, process operation 204 may take into account the previous dialogue between the user and witness and other dialogue that has occurred during the trial within the intelligent courtroom. For example, if previous questions had established that the declarant was unavailable as a witness and that the statements were made while the declarant was under the belief of imminent death, then operation 204 may classify the question as a possible exception to hearsay under Federal Rule of Evidence 804. Regardless if the intelligent legal simulator system has classified the question as a possible exception to hearsay, the system may prompt the AI educational assistant to challenge the user. For example, the AI opposing counsel may be prompted to “object” to the question on hearsay grounds, thereby forcing the user to respond accordingly. The user now has the opportunity to articulate the basis for a hearsay exception under Rule 804. The intelligent legal simulator may then be prepared to receive user response input directed to the judge and analyze the response input for the possible inclusion of phrases regarding “unavailable declarant” and “belief of imminent death.” Process operation 204 may process the user response input and proceed to determine whether the statements were sufficient to overcome the hearsay objection. In this specific instance, assuming that the simulated trial was occurring in a federal jurisdiction applying the Federal Rules of Evidence, the system may require that the user response input also make clear that the declarant's statements were about the imminent death's cause or circumstances to be deemed a correct response that overcomes the hearsay objection. Otherwise, the objection may be sustained.

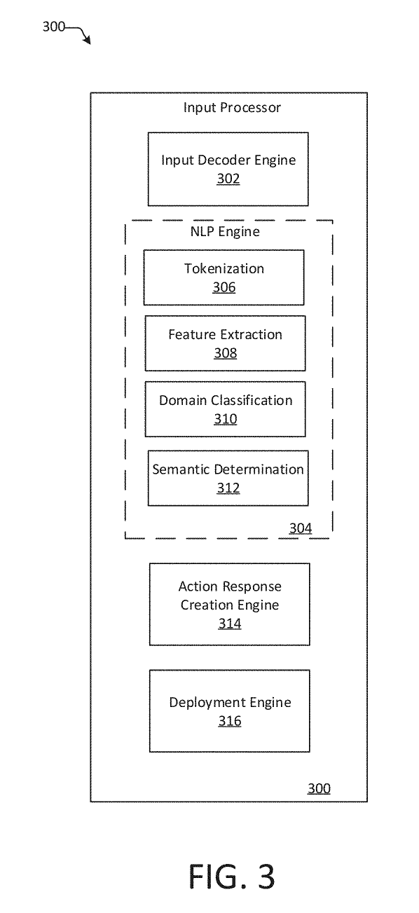

At process operation 204, raw input data may be converted from raw input data to machine-readable data. In some aspects, the machine-readable data may be stored on a local database, a remote database, or a combination of both. Process operation 204 is further discussed in detail in FIG. 3 of the input processing unit.

At determine action response operation 206, the processed results of the input may be analyzed to determine the most appropriate action response(s) to provide back to the user within the intelligent legal simulator. The input may be analyzed according to one or more rules. For example, newly received input data may be combined with previously stored data based at least upon a predefined rule. More specifically, one or more rules may be used to determine an appropriate action response based upon the newly received input. As discussed above under processing operation 204, the initial determination of an action response for the question “Then, what did she say?” may consist of a simple hearsay objection. However, determine action response operation 206 may consider previously processed dialogue that has occurred within the intelligent courtroom environment. The system may note that previous questions and answers had already laid a foundation for a possible hearsay exception under Rule 804. As such, the determine action response operation 206 may determine that the appropriate action response is to not object to the question, since it may clearly qualify as an exception to the hearsay rule. In other example aspects, the determine action response operation 206 may communicate with the AI educational assistant and determine that to further bolster the educational experience of the user, the AI opposing counsel should object to the question, thereby forcing the user to articulate a response to the hearsay objection.

In some example aspects, determine action response operation 206 may result in a default action response, an intelligent action response, or a combination of both. Some action responses may be manually programmed to activate if a certain logical sequence or sequences is satisfied. The manually-programmed action responses may be used as “base” training sets of data for the at least one NLP and/or machine-learning algorithm. For example, if a new user enters an intelligent environment within the intelligent legal simulator system, certain input from the new user may trigger default action responses due to the lack of data the system may have regarding the new user. In other example aspects, determine action response operation 206 may determine that a combination of at least one default action response and at least one intelligent action response may be most appropriate. For example, the intelligent legal simulator system may prompt the user to select a pre-processed question to ask to a witness rather than allow the user to input a custom question. The pre-processed question may be manually programmed to activate certain action responses from at least one intelligent asset within the intelligent legal simulator (e.g., AI witness, AI opposing counsel, AI judge, etc.). After the user selects one of the pre-processed questions and an action response is delivered, the system may prompt the user to enter a custom input response (e.g., via text input or speech input). The at least one NLP and/or machine-learning algorithm(s) may then receive the input via operation 202, process the input via operation 204, and determine an intelligent action response at operation 206.

In further example aspects, the determine action response operation 206 may determine to provide a non-verbal action response. For example, within the intelligent legal simulator, a user may request “a moment” before responding. The statement “Your Honor, may I have a moment” may prompt the intelligent legal simulator system to allow the user a set amount of time to look at notes, reference the law and other legal related materials, confer with an AI co-counsel, engage an AI educational assistant, etc. In this example scenario, the action response may consist of silence from at least one of the intelligent assets within the intelligent legal simulator. The action response may also include a time element, such as the amount of time allotted to the user who requested “a moment.”

The determine action response operation 206 may include a comparison function that may calculate the most appropriate action response in light of the input data and previously stored historical data. For example, the intelligent legal simulator may receive a visual feed of a user's facial expressions. The user's facial expressions may be associated with certain verbal statements and categorized accordingly. As such, the determine operation 206 may compare a currently captured image or images of a user's facial expression and compare them with previously captured expressions. For example, the comparison function of the determine action response operation 206 may determine if a user is frustrated. If a user is determined to be frustrated, the intelligent legal simulator system may activate the AI educational assistant. The AI educational assistant may then automatically provide more assistance to the user. In other example aspects, the determine action response operation 206 may consider previously applied action responses. For example, if a previously-applied action response did not yield the intended results from a user, that context may be considered at determine action response operation 206. For instance, if an action response was delivered from the AI educational assistant and the user did not reach the correct answer following the action response from the AI educational assistant, that context may be saved and noted within the intelligent legal simulator system. As such, when method 200 is activated in the future, determine action response operation 206 may consider that previously-applied action response and its level of effectiveness.

At the store input and action response operation 208, the input (also referred to as “input data”) and determined action response(s) may be stored on a local storage medium, a remote storage medium, or a combination of both. In aspects, the store input and action response operation 208 may occur in parts and may occur at earlier stages in the method. In one example aspect, the input data may be stored immediately after the process input operation 204. In another example aspect, the chosen action response may be saved immediately after the determine action response operation 206. Additionally, the store input and action response operation 208 may occur simultaneously with the determine action response operation 206 or the provide action response operation 210.

At provide action response operation 210, the intelligent legal simulator system may send the chosen action response to a specific electronic device or group of electronic devices. For example, multiple users may be operating within the intelligent legal simulator at the same time but in different locations, possibly over a shared network (e.g., network(s) 124). The action response(s) may need to reach all the users on their electronic devices (e.g., see FIG. 1). The action response may take the form of a textual message, a visual image or video, a haptic feedback (e.g., mobile device vibration), audio output, or a combination of the aforementioned forms. In aspects, the same chosen action response may be sent to two or more electronic devices. In other aspects, the chosen response stimulus may be individually tailored and sent to a single electronic device. At provide action response operation 210, the action response may be displayed on the screen of at least one electronic device. In other example aspects, the action response may be provided audibly through the speakers of an electronic device. In further example aspects, the action response may be provided as a form of haptic feedback through internal hardware of the electronic device (e.g., eccentric rotating mass motors, linear resonant actuators, piezoelectric actuators, etc.).

Provide action response operation 210 may provide a single action response or it may provide multiple action responses. Providing multiple action responses may happen simultaneously, or the action responses may be provided in a scheduled sequence as determined by determine action response operation 206.

As should be appreciated, the various methods, devices, components, etc., described with respect to FIG. 2 are not intended to limit systems 200 to being performed by the particular components described. Accordingly, additional topology configurations may be used to practice the methods and systems herein and/or components described may be excluded without departing from the methods and systems disclosed herein.

FIG. 3 is a block diagram illustrating an input processor.

Input processing unit 300 is configured to receive inputs. In some example aspects, input processing unit 300 is configured to process input data automatically according to at least one machine-learning algorithm that is trained on at least one dataset associated with at least one already-established database that may comprise court transcripts, case law, legal filings, legal articles, and other legal-related material. Additionally, the at least one machine-learning algorithm may be trained on a set of logical parameters that were manually programmed. For example, certain structures of questions or answers in an intelligent courtroom environment may have been pre-programmed to elicit specific objections from an opposing counsel asset. The inputs may include, but are not limited to, user input, non-user input (e.g., third-party database input), and a combination of both user and non-user input.

After the input data is received by the input processor 300, the input decoder engine 302 may interpret the data. Input decoder engine 302 may interpret the data by determining whether the input data should be converted to text. For example, if the input data is speech-based, then the input decoder engine 302 may determine that the speech input should be converted to text using a speech-to-text function. In another example, if the input data is handwritten (e.g., via a stylus or other electronic writing tool), the input decoder engine 302 may determine that that the handwriting input should be converted into text. In other example aspects, the input decoder engine 302 may determine that the input was non-verbal (e.g., gesture input, facial expressions, movement, sounds, etc.) and, therefore, the input should not be processed by the natural language processor (“NLP’) engine 304. Rather, the input may be transmitted directly to the action response creation engine 314.

Input decoder engine 302 may also be responsible for converting raw input data into machine-readable data. Input decoder engine 302 may be configured to accept raw data and use a data conversion scheme to transform the raw data into machine-readable data. The data conversion scheme may comprise normalizing the data and structuring the data so that the data may be consistent when it is subsequently transmitted to other engines within the input processor 300. For example, the input data may be raw text. The input decoder engine 302 may convert the raw text into a machine-readable format, such as a CSV, JSON, XML, etc. file. In other example aspects, the input data received by input decoder engine 302 may already be in machine-readable format (e.g., the input data is a CSV, JSON, XML, etc. file). If the input is determined to be in a pattern of machine-readable bits and requires no further conversion, the input data may be transmitted to another engine within the input processor 300 for further processing.

The input data may be transmitted to NLP engine 304 for further processing. NLP engine 304 may parse the input data and extract various semantic features and classifiers, among other aspects of the input data, to determine how the intelligent legal simulator system should respond to the input data. The input data may be converted into semantic representations that may be understood and processed by at least one machine-learning algorithm to intelligently disassemble the input data and determine an appropriate action response.

In some example aspects, the NLP engine 304 may include a tokenization engine 306, a feature extraction engine 308, a domain classification engine 310, and a semantic determination engine 312. The tokenization engine 306 may extract specific tokens from the input data. A “token” may be characterized as any sequence of characters. It may be a single character or punctuation mark, a phrase, a sentence, a paragraph, multiple paragraphs, or a combination of the aforementioned forms. Tokenization engine 306 may isolate key words from the input data and associate those key words with at least one intelligent action response. For example, the input data may include the word “liar” in the context of a direct or cross-examination of a witness. The keyword “liar” may be processed by the tokenization engine 306 and associated with an objection under Federal Rule of Evidence 403 (unfair prejudice). Similarly, in a direct examination within an intelligent courtroom environment, tokenization engine 306 may analyze the grammatical structure of the input data. If the grammatical structure of the input data contains a declarative or imperative statement that is turned into an interrogative fragment (“You were at the hotel on Friday, right?”), the tokenization engine 306 may associate that input with an objection for “leading.”

The tokenized input data may then be transmitted to feature extraction engine 308. Feature extraction engine 308 may extract lexical features and contextual features from the input data. These features may then be analyzed by the domain classification engine 310. Lexical features may include, but are not limited to, word n-grams. A word n-gram is a contiguous sequence of n words from a given sequence of text. As should be appreciated, analyzing word n-grams may allow for a deeper understanding of the input data and therefore provide more intelligent action responses. At least one machine-learning algorithm within the feature extraction engine 308 may analyze the word n-grams. The at least one machine-learning algorithm may be able to compare thousands of n-grams, lexical features, and contextual features in a matter of seconds to extract the relevant features of the input data. Such rapid comparisons are impossible to employ manually. The contextual features that may be analyzed by the feature extraction engine 308 may include, but are not limited to, a top context and an average context. A top context may be a context that is determined by comparing the topics and key words of the input data with a set of preloaded contextual cues (e.g., a dictionary). An average context may be a context that is determined by comparing the topics and key words of historical processed input data, historical intelligent queries and suggested action responses, manual inputs, public databases, and other data. The feature extraction engine 308 may also skip contextually insignificant input data when analyzing the textual input. For example, a token may be associated with an article, such as “a” or “an.” Because articles in the English language are usually insignificant, they may be discarded by the feature extraction engine 308. However, in other example aspects, the article may be important, as an article may delineate between singular and plural nouns and/or generic and specific nouns.

In other example aspects, feature extraction engine 308 may append hyperlinks to evidentiary objections articulated within the intelligent legal simulator system. For example, an AI opposing counsel may stand up in the simulated courtroom environment and say, “Objection, hearsay.” The phrase may appear in text on the screen of an electronic device in the form of a subtitle. The phrase “Objection, hearsay” may be processed by the input processor 300. During processing, that phrase may be transmitted to feature extraction engine 308. Feature extraction engine 308 may extract the proper name of the objection, “hearsay,” and contemporaneously append a hyperlink to that word when it is displayed on the screen as a subtitle. The hyperlink may be associated with an internal reference material, or, in other example aspects, it may be associated with a website. Additionally, other elements besides a hyperlink may be appended to the objection name. For example, a pop-up video may be appended to the word “hearsay,” so that when the user hovers over the word “hearsay” in the subtitle, a video demonstration or explanation of the evidentiary rule of hearsay is presented to the user.

After processing through the tokenization engine 306 and feature extraction engine 308, the processed input data may be transmitted to domain classification engine 310. Domain classification engine 310 may analyze the lexical features and the contextual features that were previously extracted by the feature extraction engine 308. The lexical and contextual features may be grouped into specific classifiers for further analyses. Domain classification engine 310 may also consider statistical models when determining the proper domain of the action response. To increase the speed of action response delivery, the domain classification engine 310 may analyze the extracted features of the input data, automatically construct an intelligent query based on the extracted features, fire the intelligent query against an external search engine, and return a consolidated set of appropriate action responses that matched with the intelligent query. In some example aspects, the domain classification engine 310 may be trained using a statistical model or policy (e.g., prior knowledge, historical datasets) with previous input data. For example, the phrase “Objection, hearsay” may be associated with a specific hearsay/Rule 802 token. Similarly, the phrase “Objection, hearsay” may be associated with a more generic domain classification, such as “objections” or “trial advocacy” in general.

The input data may then be transmitted to semantic determination engine 312. Semantic determination engine 312 may convert the input data into a domain-specific semantic representation based on the domain(s) that was assigned to the input by the domain classification engine 310. Semantic determination engine 312 may draw on specific sets of concepts and categories from a semantic ontologies database to further determine which action response(s) to provide to the user based on the input data. For example, a user may request to enter into evidence a photograph during a simulated trial in an intelligent courtroom environment within the intelligent legal simulator system. The phrases “Your honor” and “to enter into evidence” may be processed by the semantic determination engine 312, and the combination of those phrases may indicate to the semantic determination engine 312 that the user desires to enter a specific item into evidence.

The input data may be transmitted to the action response creation engine 314. The input data, if verbal based (e.g., speech, text, etc.), may have been processed by the NLP engine 304 prior to being transmitted to the action response creation engine 314. In other example aspects, the input decoder engine 302 may have determined that the input was non-verbal and did not require processing by NLP engine 304. Action response creation engine 314 may receive the input data, along with any processing data from NLP engine 304, and automatically create an appropriate action response. The action response creation engine 314 may draw on historical databases of user input, previously-applied action responses, user responses to the previously-applied action responses, third-party legal databases, and other sources of information. As previously described, an action response may comprise a verbal response from one of the many AI assets within the intelligent legal simulator system. In other example aspects, the action response may comprise a non-verbal response that may not be visible to a user. For example, a non-verbal action response may be an automatic command from the system to delay a verbal response of an AI asset, or it may be an allocation of time to a user to consult reference material (e.g., “Your Honor, may I have a moment?”). In some example aspects, the action response may be pre-programmed, rather than automatically generated according to at least one machine-learning algorithm. For example, not enough data may be available for the machine-learning algorithm to accurately and intelligently create an action response. As such, the action response creation engine 314 may default to a pre-programmed action response that is most closely associated to the input data and, if applicable, the data obtained from NLP engine 304.

An action response may consist of a verbal response from an AI judge, AI opposing counsel, AI witness, AI juror, AI co-counsel, and an AI educational assistant, among others. An action response may also consist of a pop-up box prompting the user to navigate to a third-party website or application for assistance. An action response may also consist of a haptic feedback, such as vibration on a mobile device, tablet, or head-mounted display.

The deployment engine 316 may be responsible for providing the action response from action response creation engine 314. Deployment engine 316 may be configured to produce a formatted and human-readable action response. Deployment engine 316 may transmit the action response or responses to at least one electronic device. Deployment engine 316 may also transmit the action response or responses to one or more users, including a subset of users. For example, in an intelligent multiplayer courtroom environment (e.g., where two users are acting as counsel against each other in an intelligent courtroom environment), both users may receive the same action response, or one user may receive a first action response, while the other user receives a second action response. The deployment engine 316 may be responsible for ensuring that the properly designated recipients and electronic devices receive the appropriate action responses as determined by the action response creation engine 314.

As should be appreciated, the various methods, devices, components, etc., described with respect to FIG. 3 are not intended to limit systems 300 to being performed by the particular components described. Accordingly, additional topology configurations may be used to practice the methods and systems herein and/or components described may be excluded without departing from the methods and systems disclosed herein.

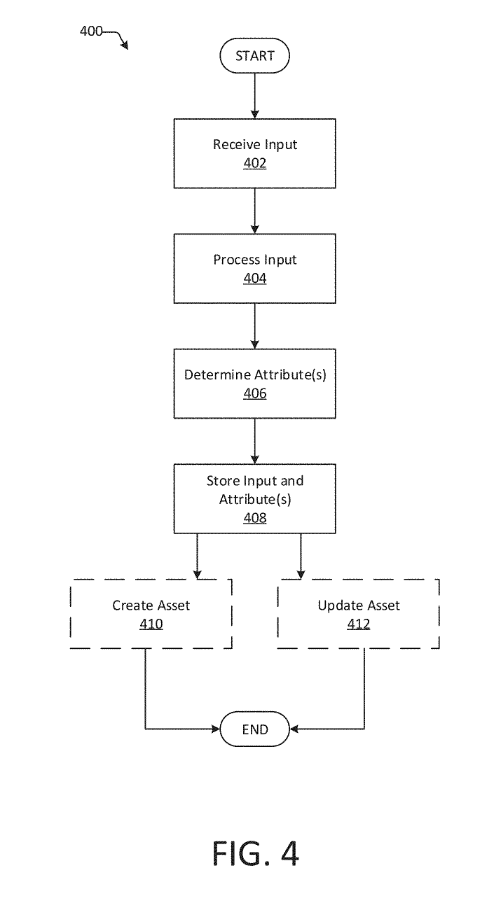

FIG. 4 is a block diagram illustrating a method for creating an artificially intelligent asset within an intelligent legal simulator.

An artificially intelligent (“AI”) asset may include, but is not limited to, an AI judge, AI opposing counsel, AI co-counsel, AI witness, AI juror, and AI educational assistant. In some example aspects, none of the AI assets may be present in an intelligent environment within the intelligent legal simulator. In other example aspects, one or more AI assets may be present within an intelligent environment. For example, in a legal simulation of a deposition, the intelligent environment may comprise a conference room, an AI opposing counsel, and an AI witness. In another example, in a legal simulation of a jury trial, the intelligent environment may comprise a courtroom, an AI judge, a first AI opposing counsel, a second AI opposing counsel, an AI co-counsel, an AI witness, and at least one AI juror.

Method 400 begins with receive input operation 402. In some example aspects, the input may be text-based. In other example aspects, the input may be audio and/or visually based (e.g., video, animation, etc.). The input may be received from a number of sources, including, but not limited to, a third-party legal database, a government database, a website, an application, an external storage device (e.g., USB), etc. For example, receive input operation 402 may read-in a trial transcript. The trial transcript may be in textual format, or it may be in audio/video format, among other formats. Receive input operation 402 may also read in a legal opinion, a motion, an order, a set of compiled statistics from a spreadsheet, etc.

Receive input operation 402 may consist of fetching data from a database. Fetching data may be performed through a number of different programming languages and platforms, including but not limited to, MySQL, PHP, Java, JavaScript, AngularJS, C#, and other programming languages and platforms. The input received by operation 402 may be received automatically. The input may also be received locally or remotely over a network (e.g., network 124). Receive input operation 402 may receive input in a number of formats, including, but not limited to, textual input, voice input, stylus input, gesture input, audio input, video input, and other input mechanisms. In some example aspects, receive input operation 402 may receive raw and/or unprocessed data. As such, receive input operation 402 may include a function of converting the raw and/or unprocessed data into a machine-readable format.

Depending on the AI asset being created, the input data that may be received at operation 402 may differ. For example, an AI judge may be programmed to automatically retrieve a specific subset of trial transcripts or legal opinions. The subset, in some examples, may be associated with a specific human judge. Specifically, an AI judge may be modeled after a currently presiding judge. The input data received at operation 402 to create such an AI judge may comprise past trial transcripts, orders, memorandums, and other relevant data associated with that specific judge. Method 400 may utilize the input data to create and/or update an AI judge that may make rulings in a similar fashion to the selected human judge.

In another example aspect, an AI opposing counsel may be created. Creating and/or updating an AI opposing counsel may consist of receiving input data in the form of trial transcripts, articles, background information, social media profiles, public data, and other relevant information. The input data may be associated specifically with a selected human attorney—currently practicing or not. For instance, an AI opposing counsel may be created and/or updated to mirror the demeanor, strategy, and/or actions of the selected attorney by receiving input data specifically associated with that selected attorney.

In yet another example aspect, an AI co-counsel may be created and/or updated. Creating and/or updating an AI co-counsel asset may consist of receiving input data in the form of current law (e.g., statutes, case law, etc.), legal articles, professional practice tips, etc. In another example aspect, an AI witness may be created/updated. The input data received for creating and/or updating an AI witness may include, but is not limited to, trial transcripts, behavioral statistical models, etc. In another example, an AI juror may be created/updated. The input data received for creating and/or updating an AI juror may include, but is not limited to, public social media profiles, statistical data relating to certain geographic areas (e.g., polls limited to certain geographic regions, other data collected regarding certain demographics), etc.

An AI educational assistant may also be created and/or updated. The AI educational assistant may manifest itself through any of the other AI assets within the intelligent legal simulator. For example, the AI judge may automatically respond to the user by providing the user with a helpful hint that the AI judge may normally not provide. The helpful hint may indicate that the AI educational assistant is operating through the simulated graphical figure of the AI judge. In other example aspects, the AI educational assistant may not manifest itself through any other AI assets. Instead, the AI educational assistant may operate through providing pop-up boxes, audio and/or video hints, simulated demonstrations, nudges to certain reference materials or websites, etc. The input data received to create and/or update the AI educational assistant may include, but is not limited to, current law (e.g., statutes, case law, etc.), best practices, treatises, legal guides, legal articles, educational materials, etc.

Process input operation 404 may automatically process the input data that was received at operation 402. The processing operation 404 may consist of applying at least one NLP algorithm and/or machine-learning algorithm to the input data received. The application of at least one NLP or machine-learning algorithm may allow the received input data to be sorted, matched, and/or analyzed quickly so that an AI asset may be automatically created and/or updated. For example, the NLP algorithm may locate key words in a legal opinion and/or article when determining the most current law. For example, the keywords “precedent,” “overturned,” “old law,” and “new law” may be flagged for deeper analysis. Additionally, some third-party databases may already provide indicators of which law(s) have been overturned and which are current (e.g., WestLaw® KeyCite® Status Flags). These indicators may be processed at process input operation 404 and utilized in the creation or updating of one or more AI assets. When the NLP algorithm is analyzing a trial transcript, the NLP algorithm may automatically search for the keyword “objection” and analyze the previous question that prompted the objection, as well as the back-and-forth discussion among the attorneys and judge following the “objection.” The processing of this data may be utilized to construct a specific AI judge and/or AI opposing counsel that may be modeled after a real, human judge or attorney.

If necessary, the input may be converted to text. For example, if input is received as speech input, a speech-to-text system (e.g., via Cortana® or Siri®) may convert the speech to text. Alternatively, if the input is received as handwritten input (e.g., via touch or stylus), a handwriting-to-text system may convert the stylus or touch input from handwriting to text. After converting the input to text, if necessary, the input may then be further processed by utilizing a natural language processor. In some example aspects, process input operation 404 may include comparing historical data regarding the user. For example, the natural language processor of operation 404 may compare current input with historical input for semantic and syntactic patterns to more accurately determine the meaning and intent of the input. In other aspects, process input operation 404 may meticulously isolate key words and phrases to identify entities associated with the input. An entity may include any discrete item associated with the input, including third-party applications, specific people or places, events, times, procedural actions, instructions, and other data that may be stored locally on an electronic device or remotely on a server (e.g., cloud server). Processing and analyzing the input to create and/or update an AI asset may occur in any intelligent environment within the intelligent legal simulator.

In some example aspects, the input data may be converted from raw input data to machine-readable data at process input operation 404. In other example aspects, as described above, the conversion to machine-readable data may occur during the receive input operation 402.

At determine attribute(s) operation 406, the processed results of the input data may be analyzed to determine the most appropriate attributes to assign to at least one AI asset within the intelligent legal simulator. An attribute may include, but is not limited to, a behavioral characteristic, a level of propensity to object or not object to a certain type of question or witness answer, level of favor with judges, level of favor with a jury in a certain district, etc. The input may be analyzed according to one or more rules. For example, newly received input data may be combined with previously stored data based at least upon a predefined rule. More specifically, one or more rules may be used to determine an appropriate attribute based upon the newly received input. In one example aspect, the input data may be utilized to create a new attribute associated with at least one AI asset. In another example aspect, the input data may be utilized to update an already-existing attribute associated with at least one AI asset. For example, an AI judge may have been automatically programmed by Method 400 to have a higher propensity of admitting expert opinion with minimal expert qualifications. However, newly received input data (e.g., in the form of trial transcripts, legal memoranda, opinions, etc.) may prompt the system to alter this attribute. For instance, if a certain human judge started requiring more qualifications in order for a witness to be tendered as an expert, such data may be received and processed by method 400. Determine attribute operation 406 may update this attribute for the AI judge asset, which is modeled after that certain human judge.

At the store input and attribute(s) operation 408, the input data and determined attributes may be stored on a local storage medium, a remote storage medium, or a combination of both. In aspects, the store input and attribute(s) operation 408 may occur in parts and may occur at earlier stages in the method. In one example aspect, the input data may be stored immediately after the process input operation 404. In another example aspect, the chosen attribute may be saved immediately after the determine attribute(s) operation 406. Additionally, the store input and attribute(s) operation 408 may occur simultaneously with the determine attribute(s) operation 406, create asset operation 410, or the update asset operation 412.

At create asset operation 410, a new AI asset may be created. For example, if a user desired to create a new AI judge modeled after a specific human judge currently presiding, the user may execute a query on the system to put method 400 in motion. Input data related to the specific judge may be received at operation 402, processed at operation 404, analyzed to determine attributes of the judge at operation 406, stored for future use at operation 408, and utilized to create an AI judge in operation 410.

At update asset operation 412, an already-existing AI asset may be updated. In some example aspects, a user may manually prompt the system to update an already-existing AI asset. In other example aspects, the system may automatically fetch data related to an already-existing AI asset and update the asset accordingly. Automatic or manual configuration may be possible within the intelligent legal simulator.

As should be appreciated, the various methods, devices, components, etc., described with respect to FIG. 4 are not intended to limit systems 400 to being performed by the particular components described. Accordingly, additional topology configurations may be used to practice the methods and systems herein and/or components described may be excluded without departing from the methods and systems disclosed herein.

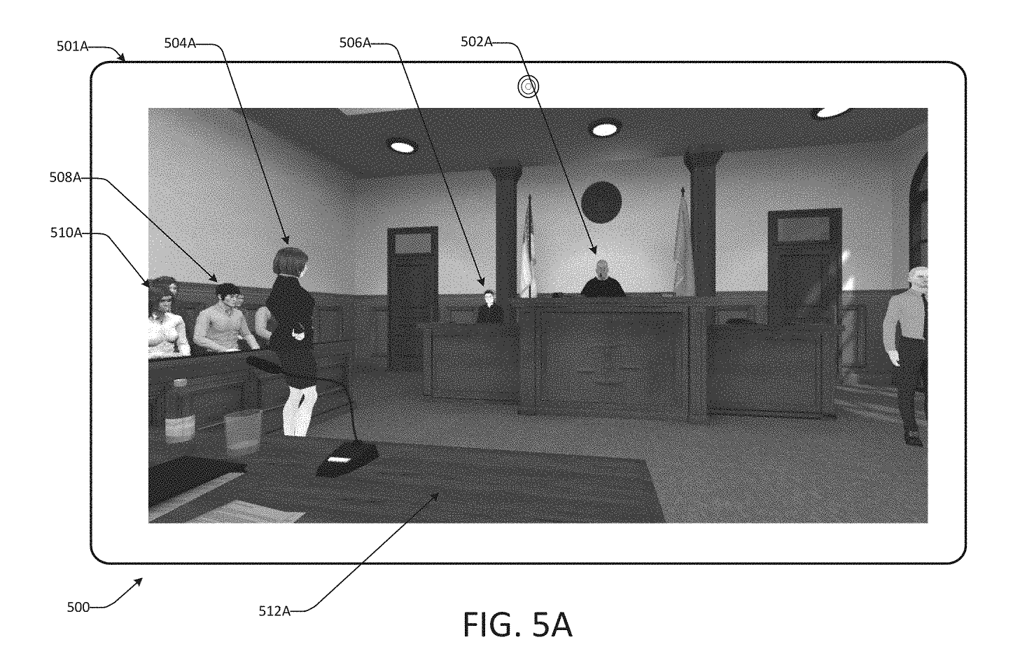

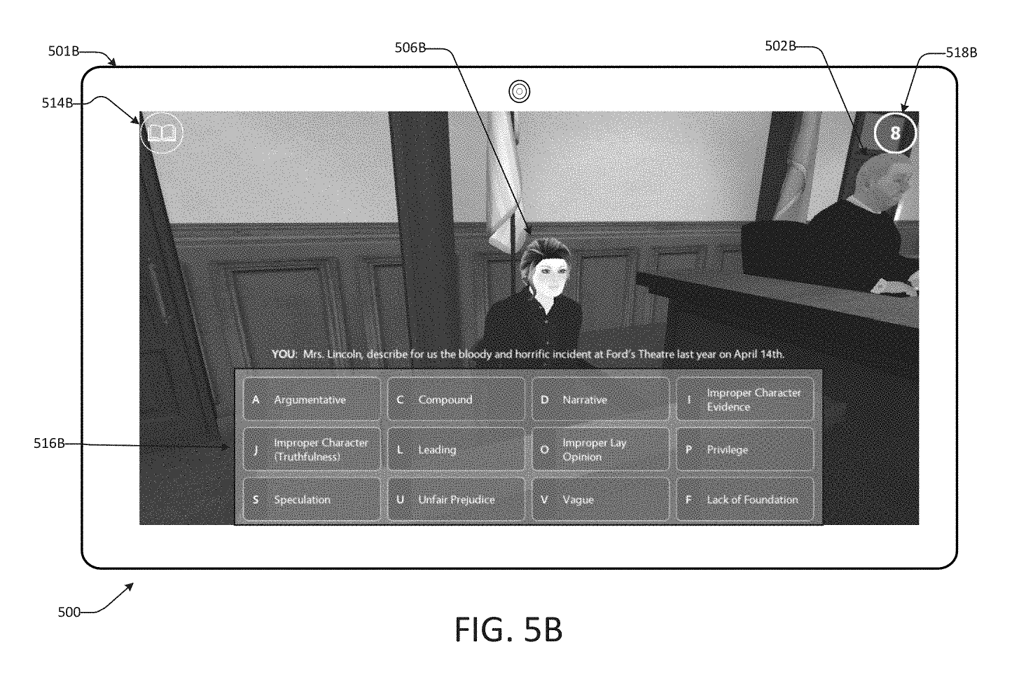

FIG. 5A illustrates an example of an electronic device running an intelligent legal simulator on an electronic device.

System 500 illustrates an intelligent courtroom environment within an intelligent legal simulator running on electronic device 501A. In this example aspect, the user may be controlling a player attorney sitting at the table in location 512A. The user may be interacting with the intelligent legal simulator from a first-person view perspective of a simulated attorney character. Within the intelligent courtroom environment, numerous AI assets may exist. For example, an AI judge asset 502A may exist. An AI opposing counsel 504A may exist. An AI witness 506A may exist. AI jurors 508A and 510A may also exist. In some example aspects, not all assets present in an intelligent environment may be artificially intelligent. For example, in some instances, the AI opposing counsel 504A may be pre-programmed to ask a series of questions to the AI witness 506A. In other instances, jurors 508A and/or 510A may not be artificially intelligent and be pre-programmed to deliver specific answers during a voir dire simulation. In further example aspects, all character assets within an intelligent environment may be artificially intelligent.

In some example aspects, an AI educational assistant may exist. Although the AI educational assistant may not be associated with a specific graphical character, the AI educational assistant may operate through the graphical characters represented by the AI assets 504A, 506A, 508A, and/or 510A. In other example aspects, the AI educational assistant may operate without the use of a graphical character and instead provide action response(s) to the user in the form of audio feedback, pop-ups, visual demonstrations, video clips, and other educational aids.

In other example aspects, the intelligent legal environment may simulate a space other than a courtroom. For instance, in a deposition simulation, the environment may be a conference room within a law firm. In a mediation or arbitration simulation, the environment may be a specifically designated mediation/arbitration room adjacent to a courtroom within a courthouse. In further example aspects, the intelligent legal environment may be associated with an international tribunal and/or country-specific courtroom layout. The intelligent legal simulator is not limited to a courtroom environment nor is it limited to a certain country and/or country's applicable laws and procedures.

FIG. 5B illustrates an example of an electronic device running an intelligent legal simulator.

System 500 illustrates an intelligent courtroom environment within an intelligent legal simulator running on electronic device 501B. In this example aspect, the user may be in a first-person perspective of a simulated attorney conducting a direct examination of a witness, specifically AI witness 506B. AI judge 502B may be presiding. In this example aspect, the intelligent legal simulator may have prompted the user to determine whether the question, “Mrs. Lincoln, describe for us the bloody and horrific incident at Ford's Theatre last year on April 14^{th.}” was proper or improper to ask the witness on direct examination. If the user indicated that the question was improper, to further reinforce the educational concept, the AI educational assistant may prompt the user to determine why the question was improper by providing a selection of objection bases on the screen of the electronic device through an objection panel 516B. In some example aspects, the AI educational assistant may prompt the user to verbally speak the proper objection basis rather than select an objection basis from the objection panel 516B. In such an instance, the intelligent legal simulator may employ a natural language processor to accurately determine the input of the user.

Additionally, the AI educational assistant may manifest itself through icons, such as reference icon 514B. Reference icon 514B may be a clickable icon that provides relevant legal and educational material related to the current scenario within the intelligent legal simulator. For example, a user may be able to access general legal reference material through icon 514B. The AI educational assistant may provide the user with the verbatim language of a certain Federal Rule of Evidence, along with a brief summary and/or examples. In other example aspects, the AI educational assistant may provide the user with specific educational hints and explanations related to an attorney question and/or witness answer. For instance, the AI educational assistant may provide a pop-up with an explanation of the proper and improper objection bases related to the specific question, “Mrs. Lincoln, describe for us the bloody and horrific incident at Ford's Theatre last year on April 14^{th}.” Specifically, the AI educational assistant may provide materials relating to the objections of “leading” and “unfair prejudice” as they may apply to that specific question.

In some example variants, a timer 518B may be present. The intelligent legal simulator system may automatically determine that providing or removing timer 518B may be beneficial to the user based at least upon the input of the user over a period of time. For example, if a user is struggling within the intelligent courtroom environment (e.g., objecting incorrectly, asking improper questions, etc.), the system may automatically determine that the timer 518B is not beneficial to the educational experience of the user. As such, the timer 518B may be automatically removed. Alternatively, the system may determine that timer 518B is too fast and adjust timer 518B accordingly. In other example aspects, the system may determine that the simulated courtroom environment is not challenging enough to the user and subsequently decrease the allotted time on the timer 518B. Alternatively, the system may determine that increasing the hostility of the judge towards the player attorney may be a more appropriate mechanism of increasing difficulty within the intelligent legal simulator.

As should be appreciated, the various methods, devices, components, etc., described with respect to FIGS. 5A and 5B are not intended to limit systems 500 to being performed by the particular components described. Accordingly, additional topology configurations may be used to practice the methods and systems herein and/or components described may be excluded without departing from the methods and systems disclosed herein.

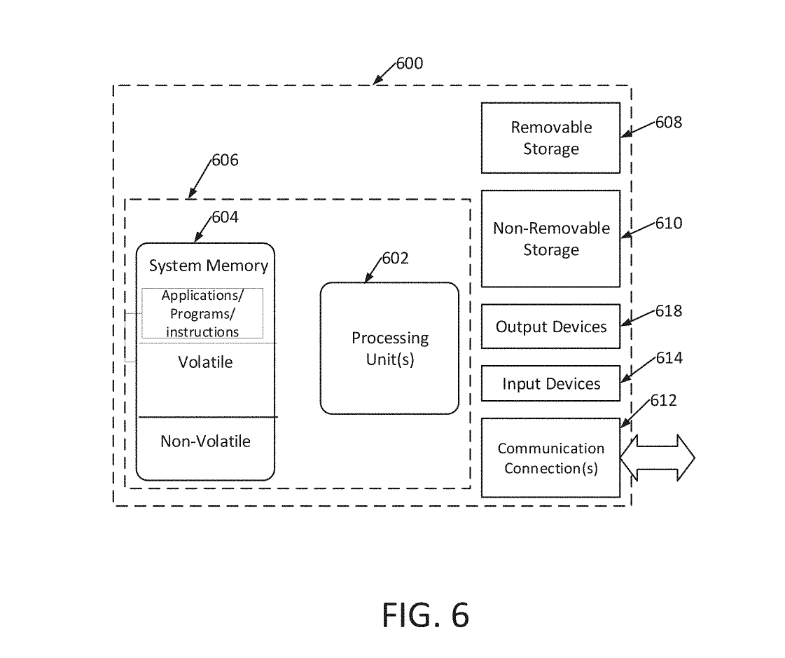

FIG. 6 illustrates a suitable operating environment for the intelligent legal simulator system described in FIGS. 1-5. In its most basic configuration, operating environment 600 typically includes at least one processing unit 602 and memory 604. Depending on the exact configuration and type of computing device, memory 604 (storing instructions to perform the automated attribution techniques disclosed herein) may be volatile (such as RAM), non-volatile (such as ROM, flash memory, etc.), or some combination of the two. This most basic configuration is illustrated in FIG. 6 by dashed line 606. Further, environment 600 may also include storage devices (removable, 608, and/or non-removable, 610) including, but not limited to, magnetic or optical disks or tape. Similarly, environment 600 may also have input device(s) 614 such as keyboard, mouse, hand-controls, HMD, pen, voice input, etc. and/or output device(s) 616 such as a display, speakers, printer, etc. Also included in the environment may be one or more communication connections, 612, such as LAN, WAN, Bluetooth, point to point, etc. In embodiments, the connections may be operable to facility point-to-point communications, connection-oriented communications, connectionless communications, etc.

Operating environment 600 typically includes at least some form of computer readable media. Computer readable media can be any available media that can be accessed by processing unit 602 or other devices comprising the operating environment. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium which can be used to store the desired information. Computer storage media does not include communication media.

Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, microwave, and other wireless media. Combinations of the any of the above should also be included within the scope of computer readable media.

The operating environment 600 may be a single computer operating in a networked environment using logical connections to one or more remote computers. The remote computer may be a personal computer, a server, a router, a network PC, a peer device or other common network node, and typically includes many or all of the elements described above as well as others not so mentioned. The logical connections may include any method supported by available communications media. Such networking environments are commonplace in offices, enterprise-wide computer networks, intranets and the Internet.

The embodiments described herein may be employed using software, hardware, or a combination of software and hardware to implement and perform the systems and methods disclosed herein. Although specific devices have been recited throughout the disclosure as performing specific functions, one of skill in the art will appreciate that these devices are provided for illustrative purposes, and other devices may be employed to perform the functionality disclosed herein without departing from the scope of the disclosure.

This disclosure describes some embodiments of the present technology with reference to the accompanying drawings, in which only some of the possible embodiments were shown. Other aspects may, however, be embodied in many different forms and should not be construed as limited to the embodiments set forth herein. Rather, these embodiments were provided so that this disclosure was thorough and complete and fully conveyed the scope of the possible embodiments to those skilled in the art.

The embodiments of the invention described herein are implemented as logical steps in one or more computer systems. The logical operations of the present invention are implemented (1) as a sequence of processor-implemented steps executing in one or more computer systems and (2) as interconnected machine or circuit modules within one or more computer systems. The implementation is a matter of choice, dependent on the performance requirements of the computer system implementing the invention. Accordingly, the logical operations making up the embodiments of the invention described herein are referred to variously as operations, steps, objects, or modules. Furthermore, it should be understood that logical operations may be performed in any order, unless explicitly claimed otherwise or a specific order is inherently necessitated by the claim language.

The above specification, examples, and data provide a complete description of the structure and use of exemplary embodiments of the invention. Since many embodiments of the invention can be made without departing from the spirit and scope of the invention, the invention resides in the claims hereinafter appended. Furthermore, structural features of the different embodiments may be combined in yet another embodiment without departing from the recited claims.

What is claimed is:

1. A processor-implemented method of creating an intelligent legal simulator, the method comprising:
receiving an input on a computing device from a user;
processing the input to identify one or more entities associated with the input, wherein at least one of the one or more entities is associated with the law;
determining at least one action response based at least in part upon analyzing the input according to one or more rules, wherein the at least one action response is associated with the law;
storing the input and the at least one action response; and
automatically providing the at least one action response.
